(19) United States
(12) Patent Application Publication
(10) Pub. No.: US 2006/0081418 A1
(43) Pub. Date: Apr. 20, 2006

(54) Ascender/descender

(76) Inventor: Morgan Thompson, Ithaca, NY (US)

Correspondence Address: Robert A. Vanderhye, 801 Ridge Dr., McLean, VA, 22101, US

(21) Appl. No.: 11/268,595

(22) Filed: Nov. 8, 2005

Related U.S. Application Data
(63) Continuation-in-part of application No. 11/052,071, filed on Feb. 8, 2005.
(60) Provisional application No. 60/575,368, filed on Jun. 1, 2004.

(51) Int. Cl. A62B 1/20

(52) U.S. Cl. 182/193

(57) ABSTRACT

An ascender/descender has two, three, or more clamping elements which in one position allow a rope to freely pass through canted aligned main openings in the elements, and in another position securely clamp the rope so that it essentially will not move with respect to the elements. The openings have a substantially completely enclosed periphery surrounding the rope. The clamping elements are in two parts, pivotal with respect to each other from an open position in which a rope may be moved sideways into the main openings, to a closed position in which the rope is held within the openings. The component parts of each clamping element are releaseably held together by a detent member and a guide pin (and associated slot). The clamping elements are pivotally connected together by a connecting element that has torsional rigidity but is flexible in at least one plane, such as a chain.

### CROSS REFERENCE TO RELATED APPLICATION

This application is a continuation-in-part of application Ser. No. 11/052,071 filed Feb. 8, 2005, the disclosure of which is hereby incorporated by reference herein (hereafter referenced as “the parent application”), which parent application claimed the priority of U.S. Provisional Application 60/575,368 filed Jun. 1, 2004.

### BACKGROUND AND SUMMARY OF THE INVENTION

The parent application illustrates and describes an advantageous ascender and descender which provides a simple, safe, fast, secure, and easy way to both climb and descend a rope. The invention provides a modification of that ascender/descender that in some ways is even simpler, and is lighter, yet just as safe and secure. One significant discovery that allows the practice of the present invention is that clamping action on a rope is enhanced if the main openings in the clamping elements each have a substantially completely enclosed periphery. However according to the invention it is still possible to move a rope into operative relationship with the main openings without having to thread an end of the rope through the openings, which oftentimes is cumbersome or may even be substantially impossible. The invention is simple, light weight, yet very safe, effective, and easy to use with a wide variety of ropes.

In this application, as in the parent application, the term “rope” is not restricted to nylon or other thread-like fibers intertwined into a conventional rope, but also includes cables, wires, lines, and other strands, as long as they are capable of being clamped by the mechanisms according to the invention. The terms “torsional rigidity” and “operatively connected” are also used as in the parent application.

According to one aspect of the present invention there is provided an ascending/descending assembly comprising: At least first and second clamping elements (preferably two or three clamping elements), each element having a first end edge, and a main opening large enough for a rope extending in a first dimension therethrough. A connecting element operatively pivotally connected adjacent the first end edges of each of the clamping elements, and connecting the clamping elements together so that the first end edges thereof are substantially aligned. And the connecting element having torsional rigidity but flexibility in at least one plane. Preferably, the connecting element comprises a chain having a pitch roughly 20-30% longer than the thickness of a clamping element. Desirably, the clamping elements have first and second side edges, and the chain comprises a plurality of chain links pivotally connected to the clamping element exteriorly of the first and second side edges thereof.

Under most circumstances the thickness of each clamping element is roughly the same as the diameter of a rope to be utilized therewith, the length of each clamping element is about three-five times the diameter of a rope to be utilized therewith, and the width of each clamping element is about two-three times the diameter of a rope to be utilized therewith.

Exactly two clamping elements may be provided, each clamping element main opening having a substantially completely enclosed periphery, with the main openings canted at an oblique angle. Regardless of the number of clamping elements, in order to allow passage of a rope through the main (enclosed periphery) openings without the necessity of threading an end of the rope through the main openings, each clamping element comprises two component parts each defining part of the completely enclosed periphery of the main opening therein. The component parts are pivotally mounted with respect to each other and movable from a first position in which the parts are releasably held together to define the substantially completely enclosed periphery, to a second position in which the parts are moved with respect to each other so that a rope may be moved sideways into the main opening (that is without threading it through the main opening). The component parts of each clamping element are preferably releaseably held together by a detent member, and by a guide pin.

According to another aspect of the present invention, there is provided an ascending/descending assembly comprising: At least first and second clamping elements, each element having a first end edge, and a main opening large enough for a rope extending in a first dimension therethrough and having a substantially completely enclosed periphery. A connecting element operating pivotally connected adjacent the first end edges of the clamping elements so that the clamping elements are movable from a first position in which the main openings therein are positioned so that a rope may pass therethrough, to a second position in which the clamping element main openings are misaligned so as to clamp a rope and substantially prevent movement thereof. And each clamping element comprising two component parts each defining part of the completely enclosed periphery of the main opening therein, the parts pivotally mounted with respect to each other and movable from a first position in which the parts are releasably held together to define the substantially completely enclosed periphery, and a second position in which the parts are moved with respect to each other so that a rope may be moved sideways into the main opening (that is without threading it through the main opening).

As described above, preferably the component parts of each clamping element are releaseably held together by a detent member, and also preferably by a guide pin. The assembly may also further comprises an attachment block connected by the connecting element to the clamping elements, and having a through extending opening therein for receipt of a rope or carabineer. The connecting element may comprise a chain, and the clamping elements main openings are preferably canted at an oblique angle (e. g. between about 20-40 degrees, e. g. about 30 degrees).

According to another aspect of the invention there is provided a clamping element for an ascender/descender, comprising: A body of metal or rigid plastic having a main opening large enough for a rope extending in a first dimension therethrough and having a substantially completely enclosed periphery, the opening canted at an oblique angle (e. g. between about 20-40 degrees). The body comprises two component parts each defining part of the completely enclosed periphery of the main opening therein, the parts pivotally mounted with respect to each other and movable from a first position in which the parts are releasably held together to define the substantially completely enclosed periphery, and a second position in which the parts are moved with respect to each other so that a rope may be moved sideways into the main opening. And a detent member and guide pin releasably holding the component parts together in the first position.

It is the primary object of the present invention to provide a simple, strong, safe, and versatile ascender/descender and methods of use thereof. This and other objects of the invention will become clear form a detailed inspection of the invention, and from the appended claims.

### BRIEF DESCRIPTION OF THE DRAWINGS

FIG. 1 is a side view of an exemplary form of ascender/descender according to the invention;

FIG. 2 is a top plan view of the attachment block of the device of FIG. 1;

FIG. 3 is a top plan view of one of the clamping elements of the device of FIG. 1 shown with the component parts thereof pivoted into a second position in which a rope may be-easily moved sideways into the main opening thereof, and with a portion shown in cross-section;

FIG. 4 is a first side view of the clamping element of FIG. 3 in the second position;

FIG. 5 is a second side view, opposite that of FIG. 4, of the guide pin-receiving component part of the clamping element of FIGS. 3 & 4 with the chain pin/shaft shown in cross-section;

FIG. 6 is a bottom plan view of the clamping element of FIGS. 3 & 4 in a first position in which the main opening therein has a substantially closed periphery; and

FIG. 7 is a top plan view of an element which can help guide a rope and which has a construction similar to that of the clamping elements of FIGS. 1 and 3-6, except that it has a straight through main opening instead of a canted one.

### DETAILED DESCRIPTION OF THE DRAWINGS

Structures illustrated in the drawings comparable to those in the parent application are shown by the same two digit reference number only preceded by a “5”.

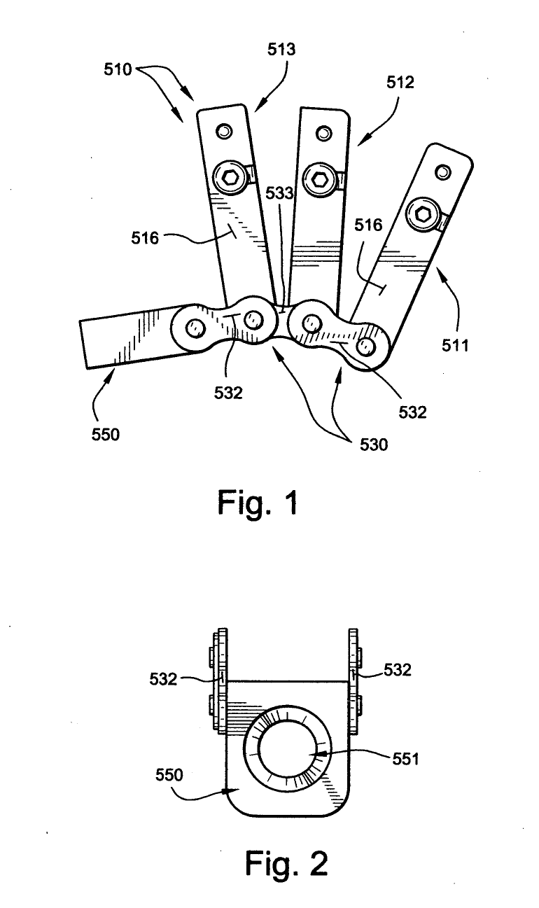

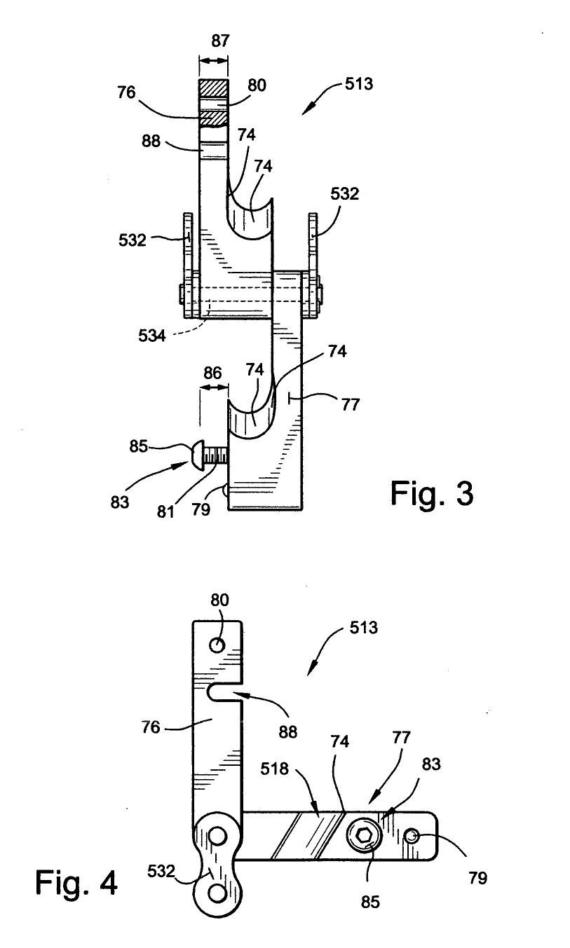

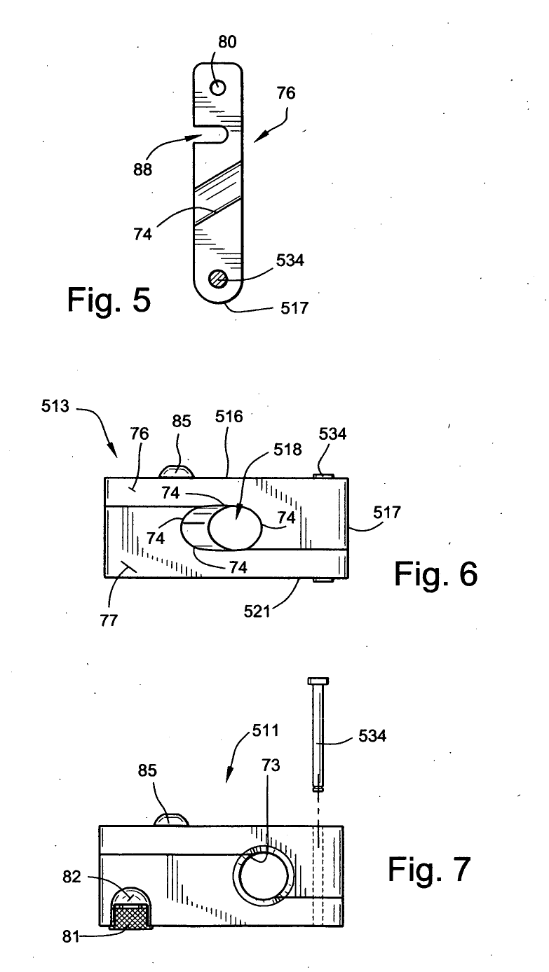

FIG. 1 shows an exemplary approximately actual size ascender/ descender assembly 510 according to the present invention. It includes at least two clamping elements 512, 513. The third element 511 illustrated may be a clamping element, having a canted main opening 518 therein as do 512 and 513, or—as illustrated in FIG. 7—it may be an attachment and/or handle element and have a straight through opening 73 therein. Each element 511-513 has a first end edge 517 (e. g. see FIGS. 3-5). A connecting element 530 is operating pivotally connected adjacent the first end edges 517 of the clamping elements 511-513 so that they are movable from a first position (FIG. 1) in which the main openings 518 therein are positioned (e. g. substantially aligned and/or loosely spaced) so that a rope may pass therethrough, to a second position (like FIGS. 8 & 11 in the parent application) in which the clamping element main openings 518 are misaligned so as to clamp a rope (like R in the parent application) and substantially prevent movement thereof.

As in the parent application, the connecting element 530 preferably has torsional rigidity but is flexible in at least one plane, preferably comprising a roller chain. Preferably the clamping elements 511-513 have first and second side edges 516, 521 and the chain comprises a plurality of chain links 532, 533 pivotally connected to the clamping elements exteriorly of the first and second side edges thereof. The details of the chain 530 may be as in any of the embodiments of the parent application, or modifications thereof, but most desirably has a configuration like that in the FIGS. 13 & 14 embodiment in the parent application.

As in the parent application, preferably the pitch of the chain 530 is roughly 20-30% longer than the thickness of a clamping element 511-513, the thickness of each clamping element 511-513 is roughly the same as the diameter of a rope to be utilized therewith, the length of each clamping element 511-513 is about three-five times the diameter of a rope to be utilized therewith, and the width of each clamping element 511-513 is about two-three times the diameter of a rope to be utilized therewith. In the embodiment illustrated in the drawings, each clamping element 511-513 has a thickness of about 0.5 inches, a length of about 2.4 inches, and a width of about 1.1 inches.

An attachment element 550, with through-extending non-canted opening 551 therein, is also preferably pivotally connected to the clamping element 513 with the chain 530.

A major difference between the assembly 510 and those of the parent application is the construction of the main opening 518 in each connecting element 511-513, and corresponding change in the nature of the elements 511-513 themselves. As most readily seen in FIGS. 34, each of the openings 518 has a substantially completely enclosed periphery 74 (see FIG. 6). Each opening 518 is also canted at an oblique angle (e. g. between about 20-40 degrees, such as about 30 degrees), as in the parent application. When a substantially completely enclosed periphery 74 is provided (instead of a slot like 19 in the parent application), fewer clamping elements 511-513 can be utilized to obtain the same clamping effect, or an enhanced clamping effect can be achieved with the same number of clamping elements. According to the invention exactly and only two clamping elements 512, 513 may be utilized, although best results are obtained when three clamping elements 511-513 are utilized (although more may be utilized if desired, or some slotted opening clamping elements with closed periphery clamping elements).

In order to obtain a closed periphery 74 while at the same allowing sideways insertion of a rope into an opening 518 (that is, not requiring threading with a free end of the rope), preferably each clamping element (e. g. see element 513 in FIGS. 2-6) comprises two component parts 76, 77, each defining part of the completely enclosed periphery 74 of the main opening 518 therein. The parts 76, 77 are pivotally mounted with respect to each other and movable from a first position (FIG. 6) in which the parts 76, 77 are releasably held together to define the substantially completely enclosed periphery 74, and a second position (FIGS. 3 & 4) in which the parts 76, 77 are moved with respect to each other so that a rope may be moved sideways into said main opening 518 (that is without threading it therethrough). The parts 76, 77 are pivotal about an axis defined by the chain pin 534 associated therewith. The parts 76, 77 are tightly, but releasably, held together (as in FIGS. 1 & 6) during use of the assembly 510 for ascending or descending, and are “opened up” (that is moved into the FIGS. 3-5 position) only when it is desired to insert a rope into openings 518, or remove a rope therefrom.

Although any conventional structure that performs a releasably holding function may be utilized, preferably the component parts 76, 77 of each clamping element (e. g. 513) are releaseably held together by a detent member. Use of a detent member provides secure holding, is unobtrusive, lightweight, readily available commercially, and easy to install and operate. One form the detent member may take is a simple spring-pressed ball or tapered end cylinder 79 (see FIGS. 3 & 4) that is installed within the body of part 77. The ball or cylinder 79, and related components (not shown), are widely available commercially, such spring plungers from mcmastercarr.com. A depression 80 aligned with the ball or cylinder 79 may be formed adjacent the end of part 76 opposite the end 517 thereof. The depression 80 may be a through extending hole (as seen in FIGS. 3 & 5), and is dimensioned to securely but releasably seat the ball or cylinder 79 therein.

Another form the detent member may take is illustrated in FIG. 7. There a conventional threaded end quick release pin available from mcmastercarr.com has a knob 81 screwed thereon, and the portion of the body of the part 77 surrounding the knob 81 is scalloped (see 82) so as to allow ready access to the knob 81 by an operator. When the knob 81 is grasped and pulled away from part 77, a spring-pressed plunger connected thereto moves out of an aligned opening or depression 80 in part 76 to allow pivotal movement between the parts 76, 77. Any other conventional form of detent may be utilized.

The component parts 76, 77 also preferably include a guide pin 83 and associated elements to assist in releasably holding the parts 76, 77 together, and to guide their movement with respect to each other, and to allow pivotal movement with respect to each other in only one direction. The guide pin 83 may take the form of a screw having a threaded shaft 84 which threads into (and then is locked in place in) an opening in part 77 adjacent ball/plunger 79, and a head 85. The bottom of the head 85 is spaced from the nearest surface of part 77 a distance 86 only very slightly greater than the thickness 87 of part 76 (see FIG. 3). A slot 88 in part 76 having a width very slightly greater than the diameter of shaft 84 is formed in alignment with the guide pin 83, to receive the shaft 84 in the FIG. 6 position.

The assembly 510 is most appropriately used by experienced climbers and therefore typically does not have other component parts. However if desired it may have any of the other features of the embodiments shown in the parent application, including one or more handles, biasing springs, or the like. As in the parent application all of the parts of the assembly 510 are preferably of metal (such as steel or aluminum) or hard plastic.

All ranges disclosed are approximate, and all narrow ranges within a broad range are also specifically disclosed herein. The invention is to be accorded the broadest interpretation of the appended claims limited only by the prior art.

What is claimed is:

1. An ascending/descending assembly comprising:
at least first and second clamping elements, each element having a first end edge, and a main opening large enough for a rope extending in a first dimension therethrough;
a connecting element operatively pivotally connected adjacent the first end edges of each of said clamping elements, and connecting the clamping elements together so that the first end edges thereof are substantially aligned; and
wherein the connecting element has torsional rigidity but is flexible in at least one plane.

2. An assembly as recited in claim 1 wherein the connecting element comprises a chain.

3. An assembly as recited in claim 2 wherein the pitch of the chain is roughly 20-30% longer than the thickness of a clamping element.

4. An assembly as recited in claim 2 wherein the thickness of each clamping element is roughly the same as the diameter of a rope to be utilized therewith.

5. An assembly as recited in claim 2 wherein the length of each clamping element is about three-five times the diameter of a rope to be utilized therewith.

6. An assembly as recited in claim 2 wherein the width of each clamping element is about two-three times the diameter of a rope to be utilized therewith.

7. An assembly as recited in claim 2 wherein the clamping elements have first and second side edges; and wherein the chain comprises a plurality of chain links pivotally connected to the clamping element exteriorly of the first and second side edges thereof.

8. An assembly as recited in claim 1 wherein exactly two clamping elements are provided, each clamping element main opening having a substantially completely enclosed periphery and wherein said main openings are canted at an oblique angle

9. An assembly as recited in claim 8 wherein each clamping element comprises two component parts each defining part of said completely enclosed periphery of the main opening therein, said parts pivotally mounted with respect to each other and movable from a first position in which the parts are releasably held together to define said substantially completely enclosed periphery, and a second position in which the parts are moved with respect to each other so that a rope may be moved sideways into said main opening.

10. An assembly as recited in claim 1 wherein each clamping element main opening has a substantially completely enclosed periphery.

11. An assembly as recited in claim 10 wherein each clamping element comprises two component parts each defining part of said completely enclosed periphery of the main opening therein, said parts pivotally mounted with respect to each other and movable from a first position in which the parts are releasably held together to define said substantially completely enclosed periphery, and a second position in which the parts are moved with respect to each other so that a rope may be moved sideways into said main opening.

12. An assembly as recited in claim 11 wherein said component parts of each clamping element are releaseably held together by a detent member.

13. An assembly as recited in claim 12 wherein said component parts of each clamping element are also releaseably held together by a guide pin.

14. An ascending/descending assembly comprising:
at least first and second clamping elements, each element having a first end edge, and a main opening large enough for a rope extending in a first dimension therethrough and having a substantially completely enclosed periphery;
a connecting element operating pivotally connected adjacent the first end edges of said clamping elements so that said clamping elements are movable from a first position in which the main openings therein are positioned so that a rope may pass therethrough, to a second position in which the clamping element main openings are misaligned so as to clamp a rope and substantially prevent movement thereof; and
wherein each clamping element comprises two component parts each defining part of said completely enclosed periphery of the main opening therein, said parts pivotally mounted with respect to each other and movable from a first position in which the parts are releasably held together to define said substantially completely enclosed periphery, and a second position in which the parts are moved with respect to each other so that a rope may be moved sideways into said main opening.

15. An assembly as recited in claim 14 wherein said component parts of each clamping element are releaseably held together by a detent member.

16. An assembly as recited in claim 15 wherein said component parts of each clamping element are also releaseably held together by a guide pin.

17. As assembly as recited in claim 14 further comprising an attachment block connected by said connecting element to said clamping elements, and having a through extending opening therein for receipt of a rope or carabineer.

18. As assembly as recited in claim 17 wherein said connecting element comprises a chain.

19. As assembly as recited in claim 14 wherein said clamping elements main openings are canted at an oblique angle.

20. A clamping element for an ascender/descender, comprising:
a body of metal or rigid plastic having a main opening large enough for a rope extending in a first dimension therethrough and having a substantially completely enclosed periphery, said opening canted at an oblique angle;
said body comprising two component parts each defining part of said completely enclosed periphery of said main opening therein, said parts pivotally mounted with respect to each other and movable from a first position in which the parts are releasably held together to define said substantially completely enclosed periphery, and a second position in which the parts are moved with respect to each other so that a rope may be moved sideways into said main opening; and
a detent member and guide pin releasably holding said component parts together in said first position.
